(19) United States
(12) Patent Application Publication
(10) Pub. No.: US 2023/0255218 A1
(43) Pub. Date: Aug. 17, 2023

(54) SMOKER DEVICE FOR THE PREPARATION OF FOODSTUFFS OR BEVERAGES

(71) Applicants: Pedro SINGLA COMA, Mollet del Vallès (ES); Albert SINGLA SALVADOR, Barcelona (ES); Jorge VIDAL HAUSMANN, Barcelona (ES); Hug PLA CORTES, Barcelona (ES)

(72) Inventor: Hug PLA CORTES, Barcelona (ES)

(21) Appl. No.: 17/794,925

(22) PCT Filed: Jan. 21, 2021
(86) PCT No.: PCT/ES2021/070038

§ 371 Date: Apr. 25, 2023

(30) Foreign Application Priority Data
Jan. 23, 2020 (ES) U202030121

(51) Int. Cl. A23B 4/052

(52) U.S. Cl. CPC A23B 4/052

(57) ABSTRACT

A smoker device for the preparation of foodstuffs or beverages, comprising a tubular main body with a frontal opening communicating with an internal combustion chamber wherein combustible, aromatic material is disposed before a grille or filter, and with a smoke outlet on the opposite side of said tubular body communicating, via an orifice foreseen for this purpose, with a hood suited to cover a container with the foodstuffs or beverages, there also being a flame generator directed through the frontal opening to burn the combustible material, generating a flow of smoke into the hood. The smoke outlet is constituted by multiple outlets, and next to the grille or filter an impurity collector is located, closing the extremity of the tubular main body.

### FIELD OF THE INVENTION

The field of application of the present invention falls within the sector of industry dedicated to the manufacture of tools, appliances and devices for cooking, bartending, catering and industrial preparation of foodstuffs or beverages, focusing particularly on those intended for smoking foodstuffs or beverages

### BACKGROUND OF THE INVENTION

From utility model ES 1184909U, whose owner is the applicant of the present invention, a smoker is known of the type that comprises a main body with a combustion chamber to receive combustible, aromatic material equipped with a frontal opening for filling and delimited at the back by a grille to hold said material but allowing the passage of smoke, which also comprises a smoke outlet arranged after the combustion chamber in the main body, a directed flame generator intended to introduce the flame through the frontal opening, and a hood, suitable in shape and size to cover a receptacle containing the foodstuff or beverage to be smoked, said hood being provided with at least one hole for introducing the smoke outlet.

Although said smoker satisfactorily fulfills its intended purpose and represents an improvement over other previously known systems for the same purpose, it still has certain aspects that can be improved.

In particular, one aspect to be improved relates to the fact that the smoke outlet is directly oriented and open towards the foodstuffs or beverages that are under the hood, lid or cover and, therefore, any carbon residue from the combustion that passes through the grille or filter falls on them, which is not desirable since it can lead to bad taste and can even be unhealthy.

Another aspect to be improved is the difficulty involved in removing the grille or filter to facilitate cleaning and/or replacement thereof, as with the current structural configuration of the smoker this is a complicated operation that must be carried out when it is cold.

Therefore, the object of the present invention is to provide the market with a new smoker that is improved in the indicated aspects as well as in other additional ones to make it more efficient and practical to use.

Likewise, another object of the present invention is to provide a smoker that is modified so as to allow the advantages of its use in the production of foodstuffs and beverages on a larger scale, both at an artisanal and industrial level, for example for the production of beverages such as wines, beers or liquors, or foodstuffs such as cereals, oils, butters, cheeses, nougats or chocolates with smoky aromas.

On the other hand, and as a reference to the current state of the art, it should be noted that the existence of any other device that has technical and structural characteristics equal to or similar to those claimed here is unknown, at least by the applicant.

### DISCLOSURE OF THE INVENTION

The smoker device for the preparation of foodstuffs or beverages proposed by the invention is configured as the ideal solution for the aforementioned object, the characterizing details that make it possible and distinguish it being conveniently collected in the final claims that accompany this description.

Specifically, what the invention proposes, as noted above, is a smoker device for the preparation of foodstuffs or beverages flavored with smoke of the type comprising a tubular main body with a frontal opening that communicates with an internal combustion chamber in which a grille or filter is provided to receive and retain the combustible, aromatic material to be burned and to generate the smoke that will provide, by way of non-limiting example: aromas, tastes or flavors, nutritional or medicinal properties, etc. (combustible and/or aromatic materials including: spices, arils, seeds, fruits, dried fruits or nuts, flowers or dried flowers, mushrooms or fungi such as truffles, vegetable bark, roots, resins, rhizomes, herbs, particularly aromatic herbs, curry-style condiments, plants, particularly medicinal plants, teas or coffees, dried vegetables, wood or its derivatives such as sawdust or chips, etc.); and a smoke outlet at the opposite end of said body which, through a hole provided for this purpose, communicates with a hood, lid or cover suitable for covering a container with the foodstuff or beverage to be smoked, also including a flame generator, ideally constituted by a torch, to direct the flame so as to introduce it through the frontal opening to burn the combustible, aromatic material.

According to the present invention, the device essentially differs in the following:

on the one hand, in that the aforementioned tubular main body, instead of a single smoke outlet oriented in a horizontal position and therefore directing the flow of smoke directly onto the food or beverages, comprises one or multiple smoke outlets oriented such that they do not direct the flow of smoke directly towards the foodstuff located below, but instead direct it towards the walls of the hood, lid or cover, for which they are preferably arranged vertically, thus enveloping the food or drinks located on the container that covers said hood, lid or cover;

and on the other hand, in that, behind the grille or filter in which the combustible, aromatic material is incorporated and before the described vertical smoke outlet(s), it also comprises an impurity collection chamber, ideally attachable or unscrewable to facilitate its opening and cleaning, where the impurities generated with the burning of said material are collected and which, due to their size, may pass through the grille or filter, thereby preventing them from falling on the foodstuffs or beverages.

Likewise, the smoker device is possibly distinguished by additionally comprising a hatch in the tubular body to place and remove the grille or filter from inside the same in a quick and simple manner, facilitating its cleaning and/or replacement, even without having to disassemble the tube from the hood, lid or cover, as it allows access from the side of the tubular body.

In this way, the smoke generated is introduced into the hood, lid or cover, which by covering the container (plate, bowl, pan, glass, cup, grill, paella pan, barbecue, griddle, etc.) that holds the foodstuffs or beverages prevents dispersion of the smoke and allows for smoking to be carried out quickly, with very little smoke—or even without smoke, using a dryer or similar heat source, sometimes but not necessarily with a slower combustion, to extract the essence of the product and aromatize or flavor without flame—and without the risk of combustion residues falling on the foodstuffs or beverages. In addition, when removing the main body (smoker) leaving the hood, lid or cover on the receptacle (for foodstuffs or beverages) the effect is still preserved, by temporarily maintaining the flow of smoke spilling out, and exiting through the opening as if it were a volcano releasing smoke while the food is being served. This effect is important, because in restaurants, clubs and other public places, more and more importance is given, along with the quality of the food and beverages served, to the staging or attention-grabbing show effect).

Thus, when removing the tubular main body, leaving the hood, lid or cover on the receptacle where the foodstuffs or beverages are located, the smoke is maintained until having decided to release it in various ways:
with the aforementioned volcano effect that releases smoke through the upper hole of the hood, lid or cover, on the way to the table or while the food is being served (releasing it through a small hole prolongs the duration);
or when uncovering the hood, lid or cover in front of the guests, looking for a “wow” or impactful effect.

The main advantages would be, among others: capturing the attention of the public, entertaining and arousing curiosity; generating interest and desire to participate; having an additional element in celebrations to introduce something or mark a high point, for example at weddings, birthdays, anniversaries, etc.; a “performance” and advertising effect, for the premises, guests, and possible sponsoring companies; and also, savings on kitchen equipment and culinary options, such as wood ovens, Josper ovens and the like, barbecues and fireplaces; along with, of course, the energy savings of firewood, electricity and charcoal, while maintaining the same effect in the mouth, the taste, the aroma, etc.

On the other hand, the flame, which is preferably directed by the flame generator, enters through the frontal opening of the combustion chamber and drives the flow of combustion smoke towards the vertical smoke outlets provided at its opposite end, collecting any impurities that said smoke may carry into the chamber provided for this purpose, allowing the smoking to be carried out in a very fast, hygienic and ecological way.

It should be noted that, although the device preferably has a directed flame generator (ideally consisting of a torch) to cause the flow of smoke into the interior of the hood, lid or cover; it may instead optionally have an internal fan, ideally powered by electricity or batteries, to help move the flow of smoke towards the interior walls of the hood, lid or cover.

Alternatively, the combustible, aromatic material (facilitating the smoky flavors) may be in the form of a pressed fuel capsule, thus also making it easier to use and making it possible to create a range of aromas and/or flavors.

For example, in an illustrative but non-exhaustive manner, the combustible, aromatic material provides: tastes or flavors; standardized or customizable to the taste of the chef/barman or consumer, independently or as a complement to the aromas; which include: spices, arils, seeds, fruits, dried fruits or nuts, flowers or dried flowers, mushrooms or fungi such as truffles, plant barks, roots, resins, rhizomes, herbs, particularly aromatic herbs, curry-style condiments, plants, particularly medicinal plants, teas or coffees, dried vegetables, wood or its derivatives such as sawdust or chips, etc.).

And, if it consists of a capsule, it ideally has the shape of a thick medallion, that is, with a circular base of little height, like the section of a cylinder, with various purposes, which include: being visually appealing to the user due to its professional and attractive design; but more importantly, facilitating the handling of the smoker and speeding up loading, which entails a competitive advantage and improved efficiency compared to other smokers, where the load is dispersed and which therefore require additional time (time is scarce in professional kitchens, which seek to satisfy customers in short time slots and in large numbers). Thus, it allows to save time; reduce staff stress (especially in the kitchen); facilitate cleaning and not generate waste.

In any case, the combustible, aromatic material, when it is a capsule, can be made of an enveloping organic component that contains other elements shredded into particles such as pellets, grains, powder or the like, or it can be made of an organic component that contains other elements in a liquid, resinous, vaporous, creamy or congealed state, or, as indicated above, it can also be made up of salts, spices, arils, seeds, flowers, dried flowers, roots, rhizomes, wood, fruits, dried fruits, nuts, dried barks, plant barks, dried and powdered vegetables, condiments (such as curry, herbs de Provence, ras el hanout, among others), plants (with special emphasis on medicinal plants), resins, and oils (especially essential oils), all of which may provide nutritional and/or medicinal properties.

In one embodiment, the tubular body of the device is incorporated into the hood, lid or cover in a vertical position through a hole made in the upper part thereof, in which case the frontal opening is located above, preferably in a bent section of the tube, and the preferably vertical smoke outlets preferably consist of a plurality of slots, but without ruling out other shapes and arrangements, made in a section of the wall on the opposite side of the tube, located internally and housed inside the hood, lid or cover, below which an impurity collection chamber is incorporated that closes the lower end of the tube, such that any impurity carried by the flow of smoke falls by gravity into said chamber before exiting.

In another embodiment, the tubular body is incorporated into the hood, lid or cover in a horizontal position through a hole made on one side thereof, in which case the frontal opening is located laterally at the front end of the external section of the tube (which may or may not be angled to facilitate introduction of the combustion and smoked flavor tablet or capsule), incorporating the grille or filter near the opposite end, inside the internal section of the tube and in an inclined position, in such a way that the combustible, aromatic material or capsule to be burned is supported on it and the lower section of tube that remains under it acts as a chamber for collecting impurities, with the smoke outlets, preferably vertical, defined by a plurality of perforations made in the base that closes said rear extremity of the tube.

In either of both embodiments, the tubular body of the device is removable from the hole of the hood, lid or cover in which it is incorporated. In addition, the tubular body optionally has a stop so that it does not slide inside the hood, lid or cover, as well as a handle to grab it to avoid burns. Said handle optionally provides a prominent space to include advertising claims or brand presence (e.g., for the restaurant or a sponsor).

In another embodiment, the smoker device, mainly applicable for the preparation of beverages in the field of bartending or mixology, preparing liqueurs, beers, infusions, teas or coffees, when it is desired to increase the production capacity of said cocktails or drinks, can comprise, as the smoke outlet from the main tubular body, one or multiple connectable outlets consisting of perforations with preferably circular connection fittings located on its perimeter at the height of the internal combustion chamber, to which one or more directional ducts are attached, preferably consisting of flexible tubes made of food-grade rubber or silicone, which allow the flow of smoke to be directed simultaneously into one or more hoods, lids or covers that cover corresponding containers with foodstuffs or beverages, without the smoker tubular body incorporated directly to them, such that they can be placed separately from it, connecting the distal end of said directional tubes through the hole made in the hood, lid or cover.

Preferably, in this case, it may be a small hole made in them specifically for this purpose, having contemplated in said holes, small or not, the existence of self-closing means, such as a silicone or similar self-closing or self-sealing stopper or anti-leak valve, in the style of a one-way flow control valve in the food industry, with the appropriate diameter to assemble one of the aforementioned tubes conveniently equipped with a connector or coupling nozzle at the end.

In this way, when removing the nozzle and the tube, the corresponding silicone anti-leak valve closes itself to prevent the exit of the smoke inside the hood, lid or cover.

To achieve this the device contemplates an accessory that can be attached to the tubular main body, specifically to its rear section, which incorporates the described connectable outlets, and which is adjusted by covering the smoke outlets of the same to be able to fit the aforementioned flexible directional ducts.

In addition, in this embodiment, the device can have a base, autonomous and independent from the hood, lid or cover, with which it obtains stability to support itself by its own weight. Alternatively, it can have elements for fastening or coupling to tables, bars, platforms and other surfaces.

In any case, the device can be completely customizable, like a Meccano Erector Set, piece by piece or by blocks, adaptable to the needs or tastes of each user.

In this sense, it should be noted that the hood, lid or cover can have different shapes and materials depending on the different applications for which the device is intended, and it can therefore be a specific element of the device itself for exclusive use with it, for example in its shape as a hood, or an element that already exists and can be used for other uses, for example in its shape as a lid for a cooking vessel or the like.

In any case, there are several advantages provided by the use of the hood, lid or cover to keep the container covered after using the smoking device of the invention:
The container (plate, bowl, paella pan or similar) arrives at the table with the hot food.
The container (plate, bowl, paella pan or similar) does not get dirty or take on any other odor.
It holds the smoke and the smell or aroma.
The hole in which the main body of the smoker is inserted is covered with a stopper, preferably a cork stopper, to regulate the smoke.
The use of this hood is especially appropriate to combine with foods prepared on the grill, parrilla grill, griddle, barbecue, without smoke, because the smoking is instantaneous and is sealed, thereby controlling the smoke.

The aforementioned use of the cork stopper to cover the hole in the hood is especially appropriate because the cork takes on the aroma and a ceremony of “uncorking” the plate of food is performed, as for a fine wine. This aspect adds one more ceremonial element, similar to a ritual in the world of fine wines, which can also include a visual element of branding or advertising, since it allows names, emblems, slogans, etc. to be engraved on the stopper. It can also be a souvenir item, since guests can keep it.

In any case, the hood, lid or cover may have different shapes to adapt to the dishes, bowls, paella pans or similar used in each case, and may be made of different types of materials suitable for foodstuffs and beverages. In addition, it may also be equipped with hooks to fasten it to the food or beverage container, for example, to attach it to a paella pan, so that it can hold the hood, lid or cover to the paella pan in a way that is easy to uncover at the appropriate time but which does not let the smoke escape before it is uncovered.

The hole in the hood, lid or cover intended for insertion of the main body of the smoker is covered with a stopper, preferably cork, in order to prevent smoke from escaping through it when said body is removed (thus allowing its reuse in the kitchen), as indicated above.

Alternatively, it may have a closing gate that slides horizontally as a peephole in a door or a hatch; or a closure or clamp with a wire tie or similar (such as that of a kitchen jar).

As for the shapes that the hood, lid or cover can take, depending on the type of food or beverage and the type of container with which the smoker is used, they will preferably be the following:
Frustoconical. A hood, lid or cover design consisting of a hollow frustoconical body, consisting of a circular base that delimits the perimeter it encompasses and therefore covers the container (plate, paella pan, grill, griddle, parrilla grill or similar device) where the food to be smoked will be placed, and a conical lateral surface, its apex being cut to define the upper hole of the hood, lid or cover, which allows insertion of the main body of the smoker and the controlled exit of smoke when withdrawing it, thereby realizing the volcano effect, due to its similarity to the eruption of a real volcano.
Truncated pyramid. A hood, lid or cover design consisting of a hollow polyhedral truncated pyramid body, consisting of a regular polygon at its base that delimits the perimeter it encompasses and therefore covers the container (plate, paella pan, grill, griddle, parrilla grill or similar device) where the food to be smoked will be placed, and a plurality of triangular lateral faces whose number coincides with the number of sides of the polygon that forms the perimeter of the base, its apex being cut to define the upper hole of the hood, lid or cover, which allows for insertion of the main body of the smoker and the controlled exit of smoke when it is removed, creating the volcano effect, due to its similarity to the eruption of a real volcano.
In the shape of a geodesic dome with a spherical base. A hood, lid or cover consisting of a body in the shape of a geodesic dome, where its faces can be triangles, hexagons or any other polygon. The vertices will (ideally) coincide with the surface of a sphere. The frequency of the geodesic dome, that is, the number of times that the edges of the icosahedron or dodecahedron are subdivided giving rise to smaller triangles, will be adapted to the design and surface of the device (paella pan, round grill, barbecue, etc.) to be covered.
In the shape of a geodesic dome with an elliptical base. A hood, lid or cover consisting of a body in the shape of a geodesic dome, where its faces can be triangles, hexagons or any other polygon. The vertices will (ideally) coincide with the surface of an ellipse. The frequency of the geodesic dome, that is, the number of times that the edges of the icosahedron or dodecahedron are subdivided giving rise to smaller triangles, will be adapted to the design and surface of the device (ellipsoidal grill or similar, ellipsoidal parrilla grill, barbecue, etc.) to be covered.
In the shape of a parallelogram. A hood, lid or cover consisting of a hollow parallelepiped body with rounded sides and a rectangular or square base with blunt vertices adapted to the design and surface of the receptacle (paella pan, grill, barbecue, etc.) to be covered.
Flat. A lid or cover consisting of a flat or semi-flat body with a bottom shape adapted to the design and surface of the container (pot, dishes, salad bowls, drainers, containers, etc.) to be covered.
Other shapes. The hood, lid or cover may have other geometric shapes to adapt to the different cooking tools or devices that may contain the foodstuffs or beverages to be smoked, including but not limited to: paella pans, barbecues, parrilla grills, grills, griddles, griddle-grills, plates, trays, salad bowls, bowls, glasses, cups, pots, pans, containers, coolers, thermal containers, etc.

In all cases, the tubular main body of the smoker will be introduced, either directly through a large hole with suitable dimensions for its insertion made for this purpose in the upper or lateral part of the body of the hood, lid or cover, or through a small hole suitable for insertion of the end of a flexible directional conduit (ideally made of food-grade silicone or similar) made in an appropriate part of the hood, lid or cover, with or without other accessories such as valves or silicone seals.

In any case, the invention also contemplates the possibility that the hood, lid or cover is an existing element (from cookware manufacturers) in which a hole will have been made to apply the body of the smoker or a smaller hole for the insertion of a smoke distribution duct with nozzle and, optionally, the placement of a self-closing valve.

As for the materials, the hood, lid or cover is ideally made, in whole or in part, of stainless steel due to its properties: non-stick and because it does not affect the taste of food, to facilitate its continuous use between changes of dishes in the kitchen (stainless steel does not impregnate with odors or flavors; its non-stick quality facilitates its final cleaning at the end of the day and maintenance due to its resistance to stains; it has a long useful life, keeping in perfect condition; corrosion resistance (facilitating its conservation and cleaning); resistance to high temperatures; prevents germs and bacteria, (due to its non-porous surface, unlike plastics, wood, etc.); provides modern aesthetics and design.

However, the hood, lid or cover will be made, in whole or in part, of any other type of material suitable for food, cooking and making cocktails, including but not limited to: glass, crystal, ceramics, terracotta, polymers suitable for use in cooking and with foodstuffs (polyethylene, Teflon, Bakelite, silicone, etc.), iron, titanium, anodized aluminum, wood or others.

Among the features of the device, it should be noted that it can preferably be completely adapted in its design for integration into furniture and appliances for kitchens and professional or group catering, including but not limited to barbecues, parrilla grills, grills, griddles, griddle-grills, warmers; coolers and refrigeration units; catering appliances, refrigerators, ovens and the like. The adaptation will be carried out either by applying the main tubular body directly to the element or by means of a flexible directional smoke supply conduit, for example to a catering cabinet; or to a hood, lid or cover made expressly or in standard formats to cover the element in question, for example a grill or a barbecue. The smoke generated is introduced into the hood, lid or cover, which prevents its dispersion by covering the container (plate, bowl, casserole, glass, cup, grill, paella plate, barbecue, etc.) that contains the foodstuff or beverage.

This has advantages at a gastronomic and nutritional level:

it smokes the product quickly;

it provides great flavor with little smoke;

there is no risk of combustion residues falling on food or beverages;

it maintains and maximizes flavors;

it maintains the nutritional and/or medicinal aspects of smoked dishes or foodstuffs.

However, it also has a series of additional advantages, which are controllable since it allows for regulation of the smoke and the intensity of the moment and presentation.

Finally, the smoking device (1) for the preparation of foodstuffs or beverages according to the invention is designed, in another embodiment, with larger dimensions in order to attach its hood, lid or cover to items consisting of artisanal or industrial containers of any type and size, from barrels to silos, for example for the production of beverages such as wines, beers or spirits, or foodstuffs such as cereals, oils, butters, cheeses, nougats or chocolates. To achieve this, it will preferably have a directed flame generator similar in size to said silos or containers, to introduce the flame through the frontal opening, held by its appropriate coupling system, and to burn the combustible aromatic material, also in this case related to the size of said silos, generating a flow of smoke towards the interior of the item, whether container or silo, from the opening made in the upper part of the same or one of its sides depending on the particularities of each product, industry or production.

### DESCRIPTION OF THE DRAWINGS

To complement the present description and in order to provide a better understanding of the characteristics of the invention, a set of drawings is attached as an integral part of this description, which is purely illustrative and not limiting, in which:

FIG. 1 schematically illustrates a side perspective view of an embodiment of the smoker device for the preparation of foodstuffs or beverages object of the invention, showing the main parts and elements that it comprises as well as the configuration and arrangement of the same, including some internals elements represented by dashed lines in an embodiment with an upper hole for the insertion of the main tubular body and hood in the shape of a frustopyramidal dome;

FIG. 2 schematically illustrates a side perspective view of another embodiment of the device according to the invention, also showing the parts and elements that it comprises, in this case in an embodiment with a side hole for the insertion of the main tubular body and conical dome-shaped hood;

FIG. 3 schematically illustrates a side perspective view of an example of the tubular main body of the device in an option that incorporates an additional body with multiple connectable outlets for directional tubes, represented prior to its coupling to said main body; and

FIG. 4 schematically illustrates a perspective view of the main body of the device with the additional body and directional tubes attached to it, and with said tubes connected in turn to two containers with a spherical dome and a flat lid, respectively.

### PREFERRED EMBODIMENT OF THE INVENTION

In view of the aforementioned figures, and according to the adopted numbering, two non-limiting embodiments of the smoking device for the preparation of foodstuffs or beverages of the invention can be seen therein, which includes what is described below.

Thus, as can be seen in said figures, the device (1) of the invention comprises, in a known manner, a tubular main body (2) with a frontal opening (3), which communicates with an internal combustion chamber (4) wherein combustible, aromatic material (5) is placed before a grille or filter (6), and with a smoke outlet (7) on the opposite side of said tubular body (2) communicating, via a hole (8) provided for this purpose, with a hood, lid or cover (9) suitable for covering a container (10) with the foodstuffs or beverages to be smoked, there also being a flame generator (11) that is directed through the frontal opening (3) to burn the combustible, aromatic material (5), generating a flow of smoke towards the interior of the hood, lid or cover (9).

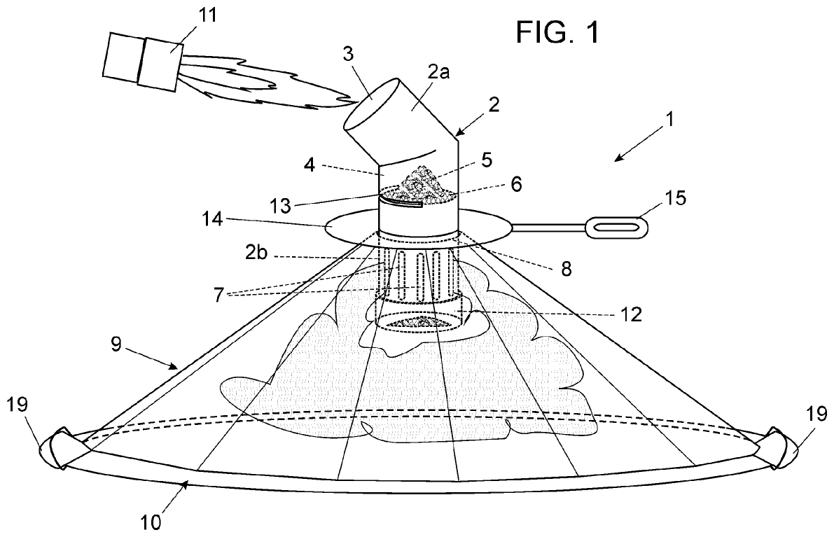

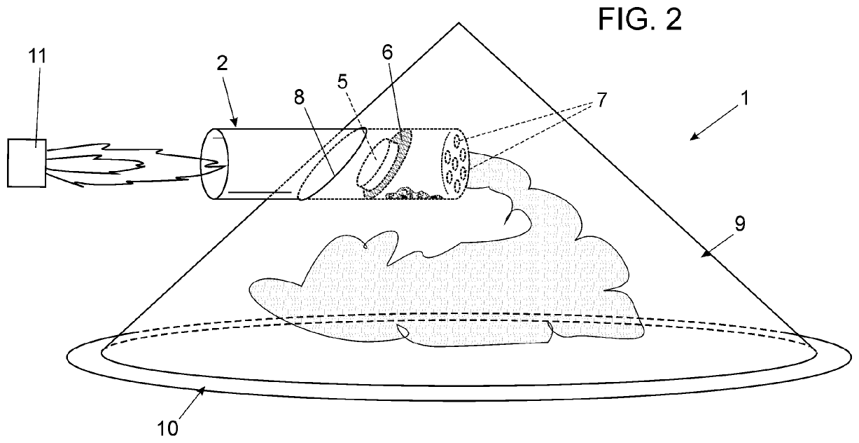

And, essentially, the device (1) is distinguished by comprising, as a smoke outlet (7) from said main tubular body (2), multiple smoke outlets (7), which, when said tubular body (2) is used partially inserted in the properly sized hole (8) of the hood, lid or cover (9), as shown in the examples of FIGS. 1 and 2, are oriented towards the inner walls of the hood, lid or cover (9), for which, preferably, they are placed in a vertical position, as well as an impurity collection chamber (12) located below the grille or filter (6), which is preferably removable to facilitate cleaning.

In addition, the tubular body (2) preferably also comprises a hatch (13), which can be opened or closed to prevent smoke from escaping, arranged on the surface of said body and which provides access to the grille or filter (6) inside to be able to place and remove it easily even without disassembling the tubular body (2) from the hood, lid or cover (9).

It should be noted that, in order to generate the flow of smoke in the main tubular body (2) towards the interior of the hood, lid or cover (9), the flame generator (11) is preferably a directed flame generator, ideally consisting of a torch, as shown in FIGS. 1 and 2, although it may optionally include an internal fan (not shown).

FIG. 1 shows how, in one embodiment, the tubular body (2), which is arranged vertically and is incorporated into the hood, lid or cover, (9) through a hole (8) of a size adjusted to said tubular body (2) made at the top thereof, has the frontal opening (3) located above, at the end of a first elbowed section (2a) of the tube, having multiple vertical smoke outlets (7) constituted, preferably, by a plurality of slots made in a second section (2b) or lower section of the wall on the opposite side of the tube (2) that is housed inside the hood, lid or cover, (9), and has the impurity collection chamber (12) as a removable receptacle that closes the lower end of the tube (2).

In this embodiment it can be seen how the device also has a stop (14) to support the tubular body (2) that rests on the hole (8) of the hood, lid or cover (9) as well as a handle (15) to grab it and uncover it, when appropriate, thereby preventing burns.

FIG. 2 shows another embodiment in which the tubular body (2) is incorporated into the hood, lid or cover (9) in a horizontal position through a hole (8) of a suitable size and laterally made in it, and has the frontal opening (3) located laterally at the front end of the external section of the tube (2).

The tubular body (2) can be straight or slightly angled; if it is straight, the introduction of the combustible, aromatic material (5) is carried out laterally, with the possibility of using a torch or other instrument, and if it is angled, it is introduced through the semi-vertical opening at the corresponding angle, and gravity helps settle it into position. The tubular body (2) can have different lengths such that the combustible, aromatic material (5) and the grille or filter (6) can be located outside the hood, lid or cover (9), speeding up its placement and removal in possible replacements.

Optionally, the tubular body (2) can be divided into separable and connectable sections, for example by threading, to place said elements with greater ease and precision, or alternatively through a hatch (13) suitably provided with a gate or similar so that it opens and closes at the height of the space where the combustible, aromatic material (5) and the grille or filter (6) are placed, to facilitate placement and cleaning, both its final cleaning and intermediate cleaning between uses with different foodstuffs, thereby avoiding the mixing of flavors.

Preferably, in this embodiment the grille or filter (6) is incorporated in an inclined position in the vicinity of the inner end of the tube (2), such that it defines a surface on which the combustible, aromatic material (5) to be burned is supported and has the impurity collection chamber (12) formed by the lower section of tube that remains under said inclined grille or filter (6), also having the preferably vertical smoke outlets (7) preferably defined by a plurality of perforations made in the wall that closes said rear end of the tube (2).

In addition, in either of the two embodiments of the device of the invention, the tubular body (2) can incorporate the stop (14) so that it does not slide inside the hood, lid or cover (9) beyond what is intended and it is removable from the hole (8) of said hood, lid or cover (9) by means of a fastening handle (15) for faster actions and to prevent burns. Optionally, said handle (15) defines a surface capable of including advertising elements.

Preferably, the hole (8) of the hood, lid or cover (9), once the smoker device has been removed, can be covered with a sealing means (not shown in the figures) that is preferably a plug of materials that absorb aromas—cork style, although this is not a limitation, as it can also be metallic, ceramic, etc., and have different shapes, such as spherical, cork stopper style, inverted cone, flat layer, and even with the possibility of incorporating decorative or advertising elements. Alternatively, the means of sealing the hole (8) of the hood, lid or cover (9) may have a gate, in the style of a hatch or similar, which slides across thereby blocking said hole (8) to prevent smoke from escaping when the tubular main body (2) of the smoker is removed.

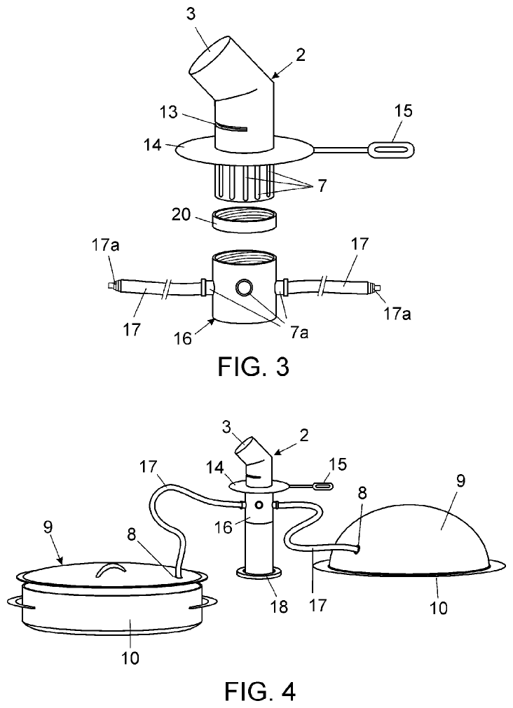

As can be seen in FIGS. 3 and 4, in another embodiment the device (1) comprises, covering the smoke outlets (7) of the tubular main body (2), an additional body (16) with one or multiple connectable outlets (7a) located on its perimeter, to which one or more directional ducts (17) are attached, preferably consisting of flexible food-grade rubber or silicone tubes that allow the flow of smoke to be directed simultaneously into the one or several hoods, lids or covers (9) located independently of the tubular body (2) and which are attached at their opposite end through a hole (8) made therein for that purpose.

Preferably, said hole (8) is of reduced size, according to the diameter of the directional ducts (17) or of the coupling nozzle that is preferably provided at the end thereof and in any case, also preferably, has a self-closing valve.

As can be seen in the aforementioned FIGS. 3 and 4, said additional body (16) is an accessory that can be attached to the bottom end of the tubular body (2) which, for example by interposing a threaded annular part (20), fits over the same covering the smoke outlets (7) used to introduce the smoke directly into the hood, lid or cover (9).

In addition, in this embodiment, the tubular main body (2) has a support base (18) that allows for its autonomous and independent support from the hood, lid or cover (9) and may alternatively include elements for fastening or attaching to tables, bars, platforms and other surfaces, although this has not been represented in the figures.

As can be seen in the various figures, the hood, lid or cover (9) has different shapes and is made of different materials, depending on the different applications for which the device (1) is intended, and it may be an element specifically manufactured for use with the device (1) or an existing element intended for other uses, for example in its shape as a cooking vessel lid that has been adapted with the hole (8) to engage the tubular body (2) or the nozzle (17a) of a directional tube (17). In addition, in any case, the hood, lid or cover (9) can have fasteners (19) for coupling to the container (10), for example as shown in FIG. 1. More specifically, in said example such holders (19) are determined by respective extensions of the surface of the hood, lid or cover (9) suitable for being inserted under the handles of the container (10).

Thus, for example, and without implying any limitation, the hood, lid or cover (9) can be frustoconical, frustopyramidal, dome-shaped with a circular base, dome-shaped with an elliptical base, a prismatic- or rectangular- or square-based parallelepiped, circular or rectangular, flat, or other shapes.

And, in terms of materials, the hood, lid or cover (9) can be made of stainless steel, glass, crystal, ceramic, terracotta, polymers suitable for use in cooking and with foodstuffs (polyethylene, Teflon, Bakelite, silicone, etc.), iron, titanium, anodized aluminum, wood or others.

Finally, it should be noted that in a preferred embodiment the combustible, aromatic material (5) can be a capsule of pressed material, preferably in the form of a tablet or disc similar to a thick medallion.

In addition, the combustible, aromatic material (5) can optionally be an organic component with other elements shredded into particles, such as pellets, grains, powder or the like, or with elements in a liquid, resinous, vaporous, creamy or congealed state, or, it can be made up of salts, spices, arils, seeds, flowers, dried flowers, roots, rhizomes, wood, fruits, dried fruits, nuts, dried barks, plant barks, dried or powdered vegetables, condiments, plants, particularly medicinal plants, resins, or oils, particularly essential oils, as well as any possible combination of said elements.

Having sufficiently described the nature of the present invention, as well as the method for putting it into practice, further explanation is not deemed necessary as any person skilled in the art will understand its scope and the advantages derived from it.

1. A smoker device for the preparation of foodstuffs or beverages, comprising:
a tubular main body including:
a front opening connected to an internal combustion chamber where combustible and flavoring material are arranged in front of a grill or filter;
a smoke outlet on the opposite side of said tubular body, which, through a hole provided for this purpose, is connected to a hood, lid or cover suitable for covering a container with foodstuffs or beverages;
a flame generator, which is driven through the front opening to burn the combustible and flavoring material generating a flow of smoke into the interior of the hood, lid or cover; and
an impurity collection tank located behind the grille or filter.

2. The smoker device for the preparation of foodstuffs or beverages according to claim 1, wherein the impurity collection tank is removable.

3. The smoker device for the preparation of foodstuffs or beverages according to claim 1, the tubular body further comprising a hatch that provides access to the inner grille or filter.

4. The smoker device for the preparation of foodstuffs or beverages according to claim 1, wherein the flame generator is a driven flame generator, optionally of noble gas, generating a flow of smoke into the tubular main body towards the inside of the hood, lid, or cover.

5. The smoker device for the preparation of foodstuffs or beverages according to claim 1 further comprising an internal fan.

6. The smoker device for the preparation of foodstuffs or beverages according to claim 1, wherein:
the hole of the hood, lid, or cover is dimensioned to insert a part of the tubular body; and
the smoke outlets are oriented towards the internal walls of the hood, lid, or cover.

7. The smoker device for the preparation of foodstuffs or beverages according to claim 6, wherein the smoke outlets are in a vertical position.

8. The smoker device for the preparation of foodstuffs or beverages, according to claim 6, wherein the tubular body is arranged vertically, being incorporated into the hood, lid, or cover through a hole made at the top thereof, the tubular body further comprising:
a front opening located at the top, at the end of a first angled section of the tube;
smoke outlets in a second section of the wall on the side opposite of the tube that is housed inside the hood, lid, or cover; and
an impurity collection tank in the form of a receptacle that closes the lower end of the tube.

9. The smoker device for the preparation of foodstuffs or beverages according to claim 6, wherein:
the tubular body is incorporated into the hood, lid, or cover in a horizontal position through a hole made laterally therein; and
the front opening is located laterally at the end of the external section of the tube.

10. The smoker device for the preparation of foodstuffs or beverages according to claim 9, wherein the tubular body is straight.

11. The smoker device for the preparation of foodstuffs or beverages according to claim 9, wherein the tubular body is angled.

12. The smoker device for the preparation of foodstuffs or beverages according to claim 9, wherein the tubular body is divided into separable and attachable sections.

13. The smoker device for the preparation of foodstuffs or beverages according to claim 9, wherein:
the grille or filter of the tubular body is incorporated in an inclined position; in the vicinity of the inner end of the tube such that the tubular body defines a surface on which the combustible and flavoring material to be burned is supported; and
the impurity collection tank is located in the lower section of the tube under the inclined grille or filter.

14. The smoker device for the preparation of foodstuffs or beverages according to claim 9, wherein the smoke outlets are arranged vertically and are defined by a plurality of perforations made in the wall that closes the rear end of the tube.

15. The smoker device for preparing foodstuffs or beverages, according to claim 6, wherein the tubular body incorporates a stop so that it does not slide inside the hood, lid, or cover beyond what is provided for.

16. The smoker device for the preparation of foodstuffs or beverages according to claim 6, wherein the tubular body further comprises a handle to extract the tubular body from the hole of the hood, lid, or cover.

17. The smoker device for the preparation of foodstuffs or beverages according to claim 16, wherein the handle defines a surface capable of including advertising elements.

18. The smoker device for the preparation of foodstuffs or beverages according to claim 6, further comprising a sealing means to cover the hole of the hood, lid, or cover.

19. The smoker device for the preparation of foodstuffs or beverages according to claim 18, wherein the sealing means to cover the hole of the hood, lid, or cover is one or more of a cork stopper, a closing gate that slides horizontally like a peephole on a door or a hatch, a closure, or a clamp with a wire tie.

20. The smoker device for the preparation of foodstuffs or beverages according to claim 1, the tubular main body further comprising:
one or more covered smoke outlets,
an additional body comprising:
one or more connectable outlets located on its perimeter;
one or more directional ducts coupled to the one or more connectable outlets that allow directing the flow of smoke simultaneously inside one or more hoods, lids or covers located independently of the tubular body and to which they are coupled at their opposite end through a hole made therein for that purpose.

21.-33. (canceled)
